(19) United States
(12) Patent Application Publication
(10) Pub. No.: US 2024/0212005 A1
(43) Pub. Date: Jun. 27, 2024

(54) ORGANIZATIONAL COLLABORATION CONNECTION RECOMMENDATIONS

(71) Applicant: Salesforce, inc., San Francisco, CA (US)

(72) Inventors: Christopher De Gour, San Francisco, CA (US); Amanda Benz, San Francisco, CA (US)

(21) Appl. No.: 18/146,181

(22) Filed: Dec. 23, 2022

(51) Int. Cl. G06Q 30/02; G06F 3/0482; G06F 3/04847; H04L 65/1073

(52) U.S. Cl. CPC G06Q 30/0281; G06F 3/0482; G06F 3/04847; H04L 65/1073

(57) ABSTRACT

Methods, systems, apparatuses, devices, and computer program products are described. A server may retrieve connection information of users of a group-based communication platform corresponding to inclusion of individual users in one or more communication channels. The server may retrieve membership information of the users corresponding to inclusion of the users in one or more groups associated with an entity. The server may generate a graphical data structure including one or more user nodes, one or more communication channel nodes, one or more group nodes, one or more edges corresponding to the connection information, one or more edges corresponding to the membership information, or any combination thereof. The server may generate an engagement recommendation for users included in a first group to engage with users of a second group of the one or more groups.

### TECHNICAL FIELD

The present disclosure relates generally to communication systems and data processing, and more specifically to organizational collaboration connection recommendations.

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

Users may communicate information using a communication platform (e.g., a group-based communication system, separate from or associated with the cloud platform). In some examples, the group-based communication system may support different groups of users sharing content within specific channels.

Users of a cloud platform or a group-based communication system (e.g., an organization or entity) may generate a large and complex set of communications across different users and groups within the organization.

### SUMMARY

The described techniques relate to improved methods, systems, devices, and apparatuses that support organizational collaboration connection recommendations. In some implementations, an application server or other computing device may analyze connections in a graphical data structure that represent user communication connections in a group-based communication platform and map these connections against groups of an organization (e.g., departmental groups of a departmental structure of a business or other organization). The application server or other computing device may generate a recommendation for a first organizational group to engage or communicate with a second organizational group based on the analysis of the connections of the individual users of the organizational groups.

One or more technical solutions described herein may solve one or more technical problems by providing engagement or connection recommendations for organizational groups that are based on already existing communications connections, thereby improving the accuracy and potential for the recommendations to be applicable and desirable for the users in the organizational groups. Further, by accounting for different characteristics of the communications connections (e.g., a quantity of users in a communication channel used or an amount of time occurring since a last communication in a communication channel), the individual connections may be weighted to better analyze and quantify the various connections, further improving the quality of the engagement recommendations.

### BRIEF DESCRIPTION OF THE DRAWINGS

FIG. 1 illustrates an example of a system for cloud computing that supports organizational collaboration connection recommendations in accordance with examples as disclosed herein.

FIG. 2 illustrates an example of a group-based communication system that supports organizational collaboration connection recommendations in accordance with examples as disclosed herein.

FIG. 3 illustrates an example of a data processing system that supports organizational collaboration connection recommendations in accordance with examples as disclosed herein.

FIG. 4 illustrates an example of a graphical data structure that supports organizational collaboration connection recommendations in accordance with examples as disclosed herein.

FIG. 5 illustrates an example of a process flow that supports organizational collaboration connection recommendations in accordance with examples as disclosed herein.

FIG. 6 illustrates a block diagram of an apparatus that supports organizational collaboration connection recommendations in accordance with examples as disclosed herein.

FIG. 7 illustrates a block diagram of a connection manager that supports organizational collaboration connection recommendations in accordance with examples as disclosed herein.

FIG. 8 illustrates a diagram of a system including a device that supports organizational collaboration connection recommendations in accordance with examples as disclosed herein.

FIGS. 9 and 10 illustrate flowcharts showing methods that support organizational collaboration connection recommendations in accordance with examples as disclosed herein.

### DETAILED DESCRIPTION

With the continued expansion of remote and hybrid workers, efficiently connecting organizational groups that should be working together becomes a challenge. While tribal or institutional knowledge may be held within teams that already work together, additional satellite networking between other groups is challenging. It may not be immediately apparent whether engagement or connection between some organizational groups that are not already engaging would be beneficial. For example, an organizational group of Sales may already be communicating with Sales Ops, but engagement between other organizational groups (e.g., Solutions with Marketing, Enablement with Sales, or Dev Rel with Technical Architects) may desirable. Determining which organizational groups should be engaging based on existing information about communications in the organization may be desirable. Some systems for recommending engagement between users may be limited in their utility to just recommending that a first user engage with a second user (e.g., because the two users are similar in some way), or that a first user engage with a particular group (e.g., because other users in the group are similar to the first user in some way). However, such systems fail to take into account or are unable to compute the potential utility of having different groups engage with each other.

In some implementations, a communication platform may calculate and sum relative graphical data structure connections (e.g., corresponding to communications on a group-based communications platform) between multiple users within an organization and then map such against the organization's departmental structure (that may include one or more organizational groups within the organization that may also be represented in the graphical data structure) to derive not just weighting of communication connection between individual users, but entire organizational groups with one another. With this information, the system may generate one or more recommendations to engage with one another and may further generate a recommendation for one or more communication channels that may be used for such engagement.

The communication platform may generate values to represent connection strengths between various users of the communication platform. Further, the communication platform may weigh the connections between the various users of the organizational groups and may do so based on one or more criteria (e.g., length of time since a last communication in a channel, voluntary inclusion in a communication channel, a quantity of users in a communication channel, one or more other criteria, or any combination thereof). In some examples, the communication platform may generate values to represent connection strengths between different organizational groups of the organization and these values may be based on the values that represent connection strengths between users.

Aspects of the disclosure are initially described in the context of a system for cloud computing. Aspects of the disclosure are then described with reference to a wireless communications system, a data processing system, and a graphical data structure. Aspects of the disclosure are further illustrated by and described with reference to apparatus diagrams, system diagrams, and flowcharts that relate to organizational collaboration connection recommendations.

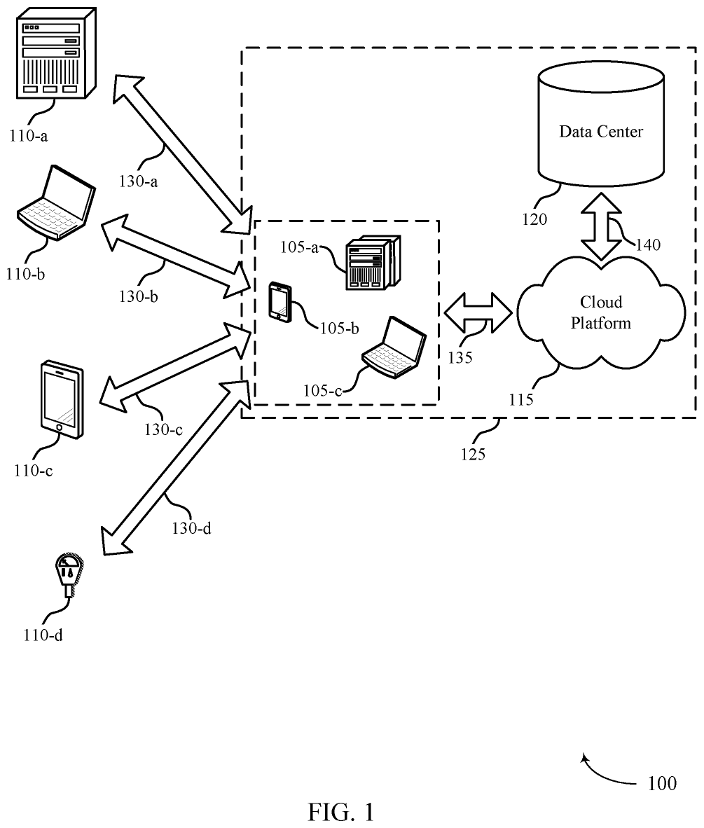

FIG. 1 illustrates an example of a system 100 for cloud computing that supports organizational collaboration connection recommendations in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a. 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization and/or team.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to-client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization, a team) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, teams, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some implementations, a communication platform that may be operated on the cloud platform 115 and the cloud platform 115 may analyze communications between cloud clients 105 made on the communications platform to determine connection strengths between the various users. The cloud platform 115 may map these user connection strengths against one or more organizational groups with which the cloud clients 105 may be associated to determine organizational group connection strengths between different users. Such analysis of connections, generations of connection strengths (both user-to-user and between organizational groups), or both may be performed in connection with a graphical data structure. The cloud platform 115 may generate one or more recommendations for organizational groups to connect or engage with one another based on the organizational group connection strengths.

Communications between users of an organization may be numerous and complex and trends or patterns present in such communications may be difficult to recognize or extract, particularly when such trends or patterns may be associated with potential connections between organizational groups (e.g., instead of potential user-to-user connections or potential user-to-group connections). Further, other approaches focus on providing simple user-to-user connection recommendations or user-to-group connection recommendations (e.g., recommending group membership to a user because a user's connection is a member of the group). However, such approaches may not be applicable to group-to-group recommendations and, as such, fail to provide insight or information about possible group-to-group recommendations.

One or more technical solutions described herein include analysis of user-to-user connections across communications channels on a communications platform to determine connection strengths between various users. Such connections may be weighted based on one or more criteria to improve the accuracy of the connection analysis. In some examples, information about the users and the communications connections may be analyzed and stored in a graphical data structure. These connections strengths are then applied against organizational groups to determine strengths of group-to-group connections based on the membership of the various users in the organizational groups and the individual connections between the users. These connections may also be analyzed and stored in the graphical data structure. An engagement recommendation may be generated based on these group-to-group connection strengths. In this way, accurate, helpful recommendations for engagement between organizational groups may be made based on the “hidden” connections or communications between individual users.

For example, a business leader may wish to better understand which organizational groups of an organization may benefit from increased engagement. The business leader may query a system that accesses connection information about users of a communications platform that are associated with the organization and communicate across one or more communications channels on the communications platform. The system may analyze communications between the various users to determine connection strengths between individual users. The system may also retrieve information about membership of the various users in the organizational groups of the organization and map the connection strengths between the individual users against the organizational groups of the organization to determine connection strengths between the organizational groups. The system may employ a graphical data structure for analysis and storage of information associated with the users, organizational groups, communication channels, and connection strengths (e.g., both user-to-user and organizational group-to-organizational group). The business leader may receive a recommendation generated by the system that indicates that one or more organizational groups may benefit from increased communication or engagement. Such a recommendation may be based on one or more of the generated connection strengths between the organizational groups.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

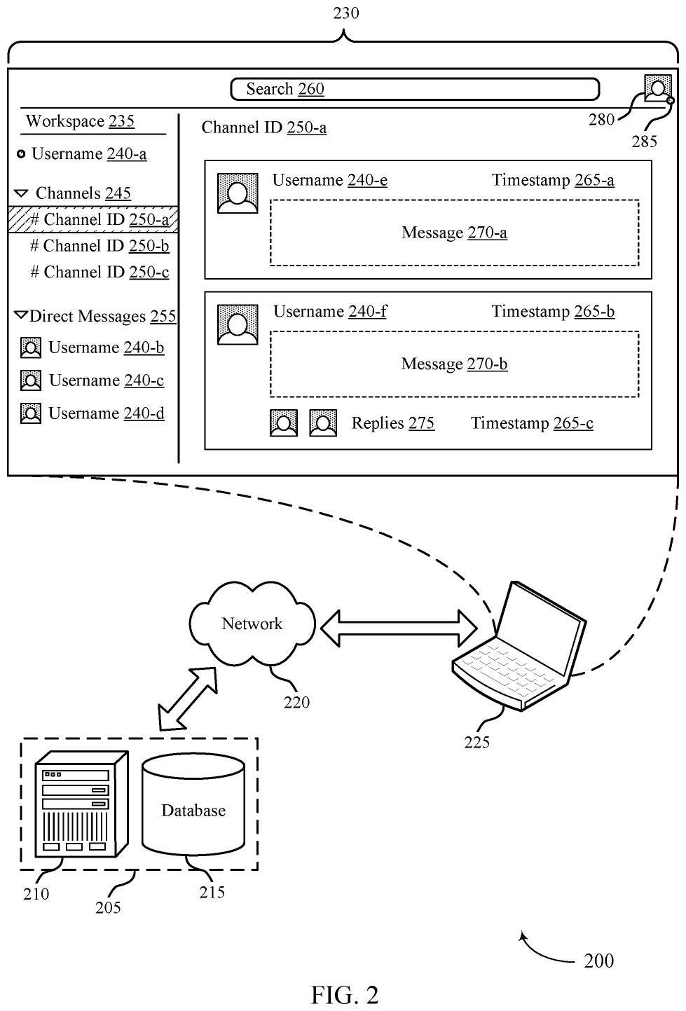

FIG. 2 illustrates an example of a group-based communication system 200 that supports automatic layout updates for document spaces in a group-based communication system in accordance with examples as disclosed herein. The group-based communication system 200 may be implemented as part of or with a system 100. For example, the group-based communication system 200 may leverage data stored at a cloud platform 115, a data center 120, or some combination thereof. The group-based communication system 200 may include a group-based communication platform 205 hosted by one or more computing devices 210, databases 215, or a combination thereof. The group-based communication system 200 may support displaying data to a user via a UI 230 of a user device 225. In some examples, the user device 225 may communicate with the group-based communication platform 205 via a network 220. In some cases, the user device 225 may be an example of a cloud client 105 or a contact 110 in a system 100, as described with reference to FIG. 1.

The group-based communication platform 205 may leverage a network-based computing system to enable users of the group-based communication platform 205 to exchange data. By being “group-based,” the platform may support communication channels, messages, virtual spaces, or a combination thereof organized into groups of users. The group-based communication platform 205 may include security policies or features that define access to resources (e.g., channels, messages) according to such groups. In some examples, the groups of users may be defined by group IDs, which may be associated with common access credentials, domains, or the like. In some examples, the group-based communication platform 205 may provide a virtual space enabling users to chat, meet, call, collaborate, transfer files or other data, or otherwise communicate within groups. In some examples, a group may be associated with a workspace 235 or team, enabling users associated with the group to communicate within the group in a secure and private virtual space. In some cases, members of a group, a workspace, or a team may be associated with a same organization (e.g., a tenant of a multi-tenant database system). In some other cases, members of a group or a workspace may be associated with different organizations (e.g., entities with different organization IDs, such as different tenants in a multi-tenant database system).

One or more computing devices 210 may support the group-based communication platform 205. For example, the one or more computing devices 210 may include an application server, a database server, a cloud-based server or service, a worker server, a server cluster, a virtual machine, a container, or any combination of these or other computing devices supporting data processing. For example, the one or more computing devices 210 may include one or more processors, memory, computer-readable media, or a combination thereof. The one or more computing devices 210 may perform functions and provide features as described herein with respect to the group-based communication platform 205. The group-based communication platform 205 may further include one or more databases 215, which may include cloud-based data storage, physical data storage, or both. In some cases, the one or more databases 215 may be memory components of the one or more computing devices 210. The one or more databases 215 may store data associated with the group-based communication platform 205. For example, the one or more databases 215 may include data relating to channels, users, workspaces 235, or any combination thereof, logs of messages 270, security information, or any other information relevant to the group-based communication platform 205.

A user may access the group-based communication platform 205 using a user device 225. The user device 225 may be an example of a laptop, a desktop computer, a smartphone, a tablet, a smart device, or any other device operated by a user and including a UI 230. The user device 225 may communicate with the group-based communication platform 205, for example, via a network 220. The network 220 may be any type of communication network, such as a local area network or a wide area network, the Internet, a wireless network, a cellular network, a local wireless network, Wi-Fi, Bluetooth®, Bluetooth Low Energy (BLE), Near Field Communication (NFC), a wired network, or any combination of these or other networks. The network 220 may support proper network protocols for transferring data between the user device 225 and the group-based communication platform 205. For example, the user device 225, the group-based communication platform 205, or both may apply one or more security protocols (e.g., encryption) for securely transferring data over the network 220. In some cases, one or more aspects of the group-based communication platform 205 may be implemented at the user device 225. For example, the user device 225 may download an application corresponding to the group-based communication platform 205 and may store information relating to the group-based communication platform 205 locally at the user device 225. In some other examples, the user device 225 may access the group-based communication platform 205 in a web browser.

The user device 225 may include a UI 230 that may display information relating to the group-based communication platform 205. Additionally, a user may interact with the UI 230 to communicate with other users, view data, modify data, or otherwise perform actions associated with the group-based communication platform 205. The group-based communication platform 205 may support multiple group-based communication channels, and the UI 230 may display information relating to a group-based communication channel corresponding to a channel ID 250-a. The UI 230 may display a sidebar including navigation information for a user and a central pane (e.g., a main pane) including the channel contents, such as a sequential listing of messages 270 corresponding to the channel ID 250-a. A channel (e.g., a group-based communication channel) may provide a virtual space for a group of users to communicate via messages, hangouts, video or audio calls, files, or any other means of communication. The group of users may include members of the channel, non-members of the channel with access to the channel, or both.

A user may log into the group-based communication platform 205 (e.g., using a username 240-a, a password, or both corresponding to a user account). In response to the user logging in, the group-based communication platform 205 may send, for display in the UI 230, data corresponding to the user (e.g., corresponding to an account for the user). For example, the user may be associated with a specific workspace 235, a set of channels 245, a set of connections, a set of threads, a set of direct messages 255, or any combination of these. The user device 225 may retrieve or otherwise access the relevant information for the user (e.g., based on the username 240-a or another user ID) and surface the information for display in the UI 230 according to a display format.

As an example, in a sidebar (e.g., a navigation pane), the UI 230 may display an indication of a workspace 235 corresponding to the user and the username 240-a of the user. The sidebar may further include indications of a set of channels 245 using the respective channel IDs. For example, the set of channels 245 may include the channels to which the user is a member. As illustrated, the set of channels 245 may include a first channel corresponding to a first channel ID 250-a, a second channel corresponding to a second channel ID 250-b, and a third channel corresponding to a third channel ID 250-c. It is to be understood that the set of channels 245 may include any quantity of channels for selection by the user. The user may select a channel from the listing of the set of channels 245, and the UI 230 may display the selected channel (e.g., the messages 270 associated with the selected channel) in the central pane. The sidebar may further include a set of direct messages 255 between the user with the username 240-a and one or more other users (e.g., in a DM group). For example, the set of direct messages 255 may include the usernames 240 (or nicknames) of the users communicating via direct messages with the user. In some examples, the list of users may include users added by the user with username 240-a, users who have current, ongoing direct message conversations with the user with username 240-a, or both. As illustrated, the set of direct messages 255 may include indications of a user with a first username 240-b, a user with a second username 240-c, and a user with a third username 240-d, although any quantity of users may be included in the set of direct messages 255. Selecting a username 240 from the set of direct messages 255 may cause the UI 230 to display a set of direct messages between the logged in user and the selected user or group of users in the central pane (e.g., direct messages that are stored in the system and displayed in a sequential order).

The central pane of the UI 230 may display the contents of a selected channel. For example, if the user selects a channel with a channel ID 250-a, the central pane may display the selected channel ID 250-a, as well as data corresponding to this selected channel ID 250-a. The data for the channel may include a sequential listing of messages 270 posted to the channel. For example, a user with a username 240-e may post a first message 270-a at a first time corresponding to a timestamp 265-a. The UI 230 may display, for the channel, this information, as well as affordances supporting actions associated with this information. For example, a user may react to the message 270-a, reply to the message 270-a, or both. As illustrated, another user with a username 240-f may post a second message 270-b at a time corresponding to a timestamp 265-b, and one or more users may reply to the message 270-b. The UI 230 may indicate a set of replies 275 and one or more timestamps 265-c associated with the replies 275 (e.g., a timestamp 265-c corresponding to a most recent reply) with the message 270-b. Selecting the set of replies 275 may cause the UI 230 to display the replies in a second sidebar (e.g., as a thread of messages).

The messages 270 may include text or other objects, such as files, photos, audio files, video files, documents, uniform resource locator (URL) links, or any other objects. If the selected channel is private, member of the channel may view the information related to the channel, while nonmembers of the channel may be blocked from viewing the information. If the selected channel is public, members and nonmembers of the channel may view the relevant information. In some cases, channels, users, workspaces 235, accounts, or some combination thereof may include accessibility settings or rules with may define viewing capabilities, editing capabilities, or both.

The UI 230 may further support search functionality using a search bar 260. Additionally, or alternatively, the UI 230 may indicate a profile picture 280 of the currently logged in user, as well as a connection status 285 (e.g., online, offline, busy) of the user.

In some implementations, the group-based communication platform 205 may analyze communications made over one or more of the channels 245 between the users of the communications platform to determine connection strengths between the users. The users may be referred to as a team of users (e.g., a team defined within the group-based communication system or platform). The group-based communication platform 205 may map these user connection strengths against one or more organizational groups with which the users may be associated to determine organizational group connection strengths between different users. Such analysis of connections, generations of connection strengths (both user-to-user and between organizational groups), or both may be performed in connection with a graphical data structure. The group-based communication platform 205 may generate one or more recommendations for organizational groups to connect or engage with one another based on the organizational group connection strengths and may further generate one or more recommendations for one or more channels 245 over which such communications may be made.

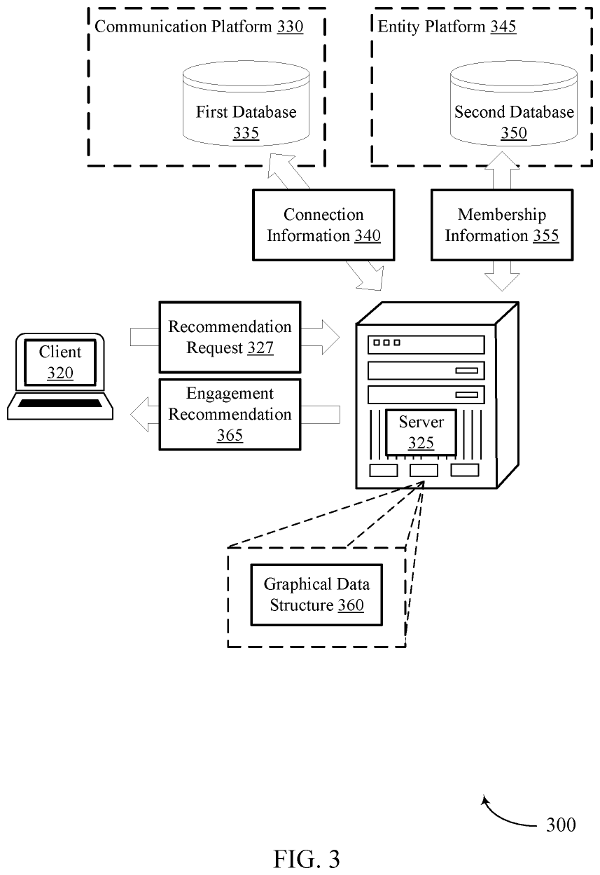

FIG. 3 illustrates an example of a data processing system 300 that supports organizational collaboration connection recommendations in accordance with examples as disclosed herein. The data processing system 300 may include a client 320, a server 325, a communications platform 330, a first database 335 associated with the communications platform 330, an entity platform 345, and a second database associated with the entity platform 345.

In some examples, the client 320 may transmit a recommendation request 327 to the server 325. In response, the server 325 may perform one or more actions to retrieve the connection information 340 and the membership information 355, to generate a graphical data structure 360, analyze the connection information 340 and the membership information 355, and generate the engagement recommendation 365.

In some examples, the server 325 may retrieve the connection information 340 from the first database 335. The connection information 340 may include information about the user's relationships to communication channels of the communications platform 330. For example, the communication information 340 may include information about communications made by users, such as dates, times, content, one or more communications channels used (e.g., group messages, private or one-on-one messages, video chats, audio chats), information about the communications channels used (e.g., a quantity of users associated with or participating in the channel, an amount of time since a last communication made in a channel, lengths or sizes of communications made in the channel, types of communications made in the channel, such as voice, video, text, one or more other channel characteristics or information, or any combination thereof), types of communications made, length of a communication, a size of a communication, “opt-in” information for a user in a communication channel (e.g., whether a user voluntarily joined a communication channel, whether another user added the user to the communication channel, whether joining the communication channel is optional or mandator, other information, or any combination thereof), metadata, other information about communications made by users, or any combination thereof. Additionally, or alternatively, the connection information 340 may indicate membership of the users in different communication groups associated with the communication platform 330.

The server 325 may retrieve such connection information 340 for some subset of users of the communications platform 330 (e.g., as specified in the recommendation request 327) or for all users of the communications platform 330 (e.g., those users associated with an organization and/or a team). For example, the connection information 340 retrieved for a user may include a user identifier and a communication channel identifier, though the connection information 340 may also include other information as described herein. In some examples, the connection information 340 may be organized by user, by communication channel, by one or more other criteria, or any combination thereof.

In some examples, the communication platform 330 may include one or more tables, other data structures, or both, for storing the connection information 340 in the first database 335. In some examples, the communication platform 330 (and, optionally, the connection information 340) may include information about “opt-in” membership of the users in one or more communications channels.

In some examples, the server 325 may retrieve the membership information 355 from the second database 350 (optionally associated the entity platform 345). The membership information 355 may indicate which users of the communications platform 330 are associated with which organizational groups of the organization. For example, the membership information 355 may be an organizational chart or an organizational data structure that indicates the relationships between one or more users and one or more organizational groups of the organization. In some examples, a user may be associated with or may be a member of multiple organizational groups.

In some examples, the server 325 may generate a graphical data structure 360 to organize, analyze, store, or otherwise process the connection information 340, the membership information 355, to generate the engagement recommendation 365. The graphical data structure 360 may include one or more nodes, one or more edges, or both, which may represent one or more aspects of the connection information 340, the membership information 355, or both. Another example of the graphical data structure 360 is discussed further herein.

In some examples, the server 325 may generate, the engagement recommendation 365 based on the connection information 340, the membership information 355, the graphical data structure 360, or any combination thereof. In some examples, the engagement recommendation may include an engagement recommendation for users included in a first organizational group to engage with users included in a second organizational group. Additionally, or alternatively, the engagement recommendation 365 may include one or more recommendations for a communication channel over which the users of the first and second organizational groups may engage. Though an example of first and second organizational groups is used here, the engagement recommendation 365 may include one or more recommendations for any quantity of organizational groups.

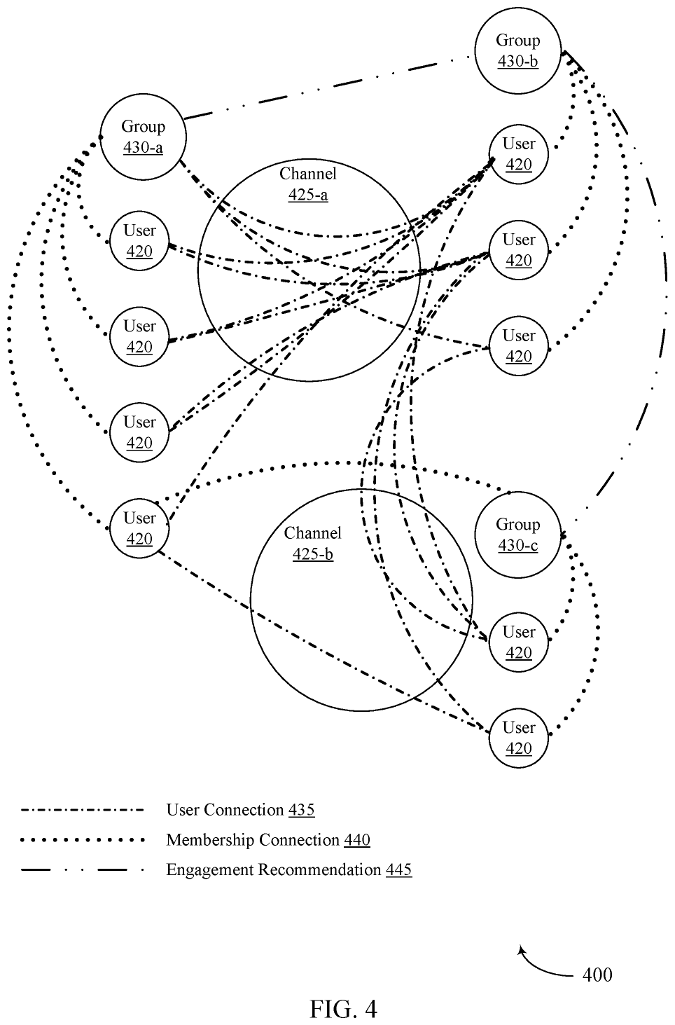

FIG. 4 illustrates an example of a graphical data structure 400 that supports organizational collaboration connection recommendations in accordance with examples as disclosed herein.

The graphical data structure may include indications of one or more users 420, which may be represented in the graphical data structure 400 by one or more nodes. The graphical data structure may include indications of one or more groups 430, which may be represented in the graphical data structure 400 by one or more nodes. The graphical data structure may include indications of one or more channels 425, which may be represented in the graphical data structure 400 by one or more nodes, one or more edges, one or more other indications, or any combination thereof.

The graphical data structure may include indications of one or more user connections 435, which may be represented in the graphical data structure 400 by one or more edges. The graphical data structure may include indications of one or more membership connections 440, which may be represented in the graphical data structure 400 by one or more edges. The graphical data structure may include indications of one or more engagement recommendations 445, which may be represented in the graphical data structure 400 by one or more edges.

As described herein, a server or other computing device may retrieve connection information corresponding to the one or more users 420 that may include relationship information of the one or more users 420 with one or more channels 425, one or more user connections 435 between one or more users 420. In the figure, a user connection 435 passing through the representation of a channel 425 may indicate that the connected users 420 communicated with each other using the channel 425. The connection information may be indicated in the graphical data structure 400 at least partially by the user connections 435.

As described herein, the server or other computing device may retrieve membership information corresponding to the one or more users 420 that indicates one or more organizational groups to which the one or more users 420 belong. After retrieving the membership information, the server or other computing device may establish the membership connections 440 in the graphical data structure 400 based on the membership information.

In some examples, the server or other computing device may iterate through one or more user connections 435, relationships between users 420 and channels 425, or both to determine or generate a weight for one or more user connections 425, one or more channels 425, or both. Such a weighting may be based on one or more factors or criteria, including a length of time since a last communication in a channel, voluntary inclusion in a communication channel, a quantity of users in a communication channel, one or more other criteria, or any combination thereof. Some or all such criteria may initially be included in the connection information and may be applied to the user connections 435, the channels 425, or both.

For example, a weight may be assigned or generated for a channel or for a user connection 435. For example, based on a criteria of a quantity of connections associated with a channel, a greater weight may be generated for the channel 425-a than a weight for the channel 425-b, given the difference in the quantity of connections. In some examples, a weighting for a channel 425 may be represented by a formula, such as channel_weight=(K/channel_user_count)*(//days_since_last_post+1) where K and/are predefined constants that may balance the formula as desired. Though the example of a channel 425 is discussed here, the example and the formula discussed apply equally to a single user connection 435, a group of user connections 435, or other relationship between one or more users 420.

In some examples, the server or other computing device may sum or combine the weights for some or all of the user connections 435 for each pair of users 420. Once all such weights for the user connections 435 are generated, calculated, or otherwise obtained, the weights may be mapped against the membership connections 440 to group and sum the values of the user connections 435 (optionally modified by the weights as described herein) by the groups 430 and generate group-to-group connection strengths.

Based on these group-to-group connection strengths, the server or other computing device may generate one or more engagement recommendations 445. The engagement recommendations may indicate that it may be desirable for a group 430 to engage with another group 430.

As an illustrative and non-limiting example, in FIG. 4, the users 420 associated with group 430-a have many user connections 435 with users 420 associated with group 430-b. However, the users 420 of group 430-a have few connections with users 420 of group 430-c, while users 420 of group 430-b have a moderate amount of user connections 435 with users 420 of group 430-c. As described herein, a server or other computing device may iterate through some or all of the user connections 435 and may assign a weight to one or more user connections, one or more channels 425, or both. Based on the user connections 435, the channels 425, one or more weights assigned to one or more user connections 435, one or more channels 425, or any combination thereof, the server or computing device may determine connections strengths between individual users 420, which may then be mapped against the different groups 430 to determine connection strengths between the groups 430. In the example of FIG. 4, the connection strength between group 430-a and 430-b, as well as the connection strength between group 430-b and group 430-c are sufficient to generate engagement recommendations 445 between group 430-a and 430-b, as well as between group 430-b and group 430-c. In some examples, the engagement recommendations 445 or one or more indications of the engagement recommendations 445 may stored in the graphical data structure 400.

In some examples, it may be determined that a connection strength between groups 430 is sufficient to generate an engagement recommendation 445 based on the connection strength between the groups 430 exceeding or otherwise satisfying a connection strength threshold. Additionally, or alternatively, connection strength between groups 430 may be determined to be sufficient to generate an engagement recommendation 445 based on a ranking of a connection strength between groups 430 compared to a connection strength between other groups 430. Various options for sufficiency of the connection strength between groups 430 may be employed, either in isolation or in combination.

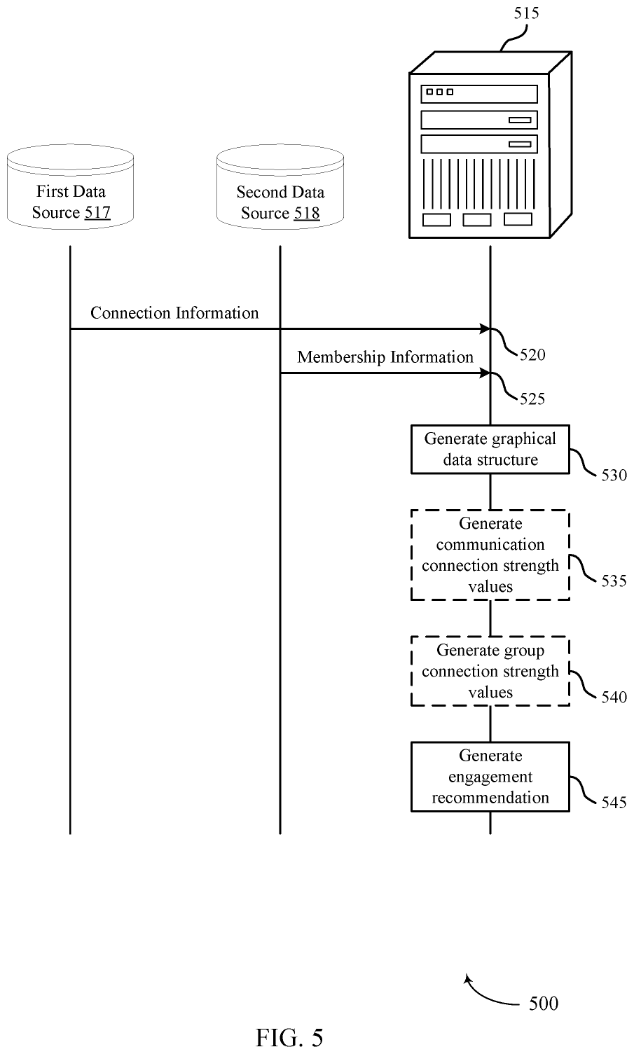

FIG. 5 illustrates an example of a process flow 500 that supports organizational collaboration connection recommendations in accordance with examples as disclosed herein. The process flow 500 may implement by various aspects of the present disclosure described herein. The elements described in the process flow 500 (e.g., the server 515, the first data source 517, and the second data source 518) may be examples of similarly-named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the server 515 may retrieve, from a first data source 517 associated with a group-based communication platform associated with an entity, connection information of a plurality of users of the group-based communication platform, the connection information corresponding to inclusion of individual users of the plurality of users in one or more communication channels of the group-based communication platform. In some examples, the one or more communication channels may include one or more group communication channels, one or more one-on-one communication channels, or any combination thereof.

At 525, the server 515 may retrieve, from a second data source 518 associated with the entity, membership information of the plurality of users, the membership information corresponding to inclusion of the individual users of the plurality of users in one or more groups of a plurality of groups associated with the entity. In some examples, the one or more groups associated with the entity correspond to one or more functional roles of the plurality of users within the entity. In some examples, the first data source 517 and the second data source 518 may be associated with different applications (e.g., software applications or platforms). For example, the first data source 517 may be associated with a group-based communication application or platform and the second data source 518 may be associated with an application that stores organizational hierarchical information about an entity, such as a human resources application.

At 530, the server 515 may generate a graphical data structure that may include one or more user nodes corresponding to identifiers for the plurality of users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof.

At 535, the server 515 may generate communication connection strength values between the individual users indicated in the connection information based on one or more communication connections between the individual users. In some examples, the engagement recommendation is generated based on generating the communication connection strength values. In some examples, the one or more communication connections between the individual users are weighted based on a quantity of interaction events performed by the individual users, a quantity of the individual users participating in the one or more communication channels, a period of time since a last interaction event occurred in the one or more communication channels, whether the individual users voluntarily joined the one or more communication channels, or any combination thereof.

At 540, the server 515 may generate group connection strength values between individual groups of the plurality of groups associated with the entity based on the membership information and the communication connection strength values between users of the individual groups. In some examples, the engagement recommendation is generated based on a first group connection strength value of the group connection strength values that is associated with the first group and the second group.

At 545, the server 515 may generate, based on the connection information, the membership information, and the graphical data structure, an engagement recommendation for users of the plurality of users included in a first group of the one or more groups to engage with users of the plurality of users included in a second group of the one or more groups.

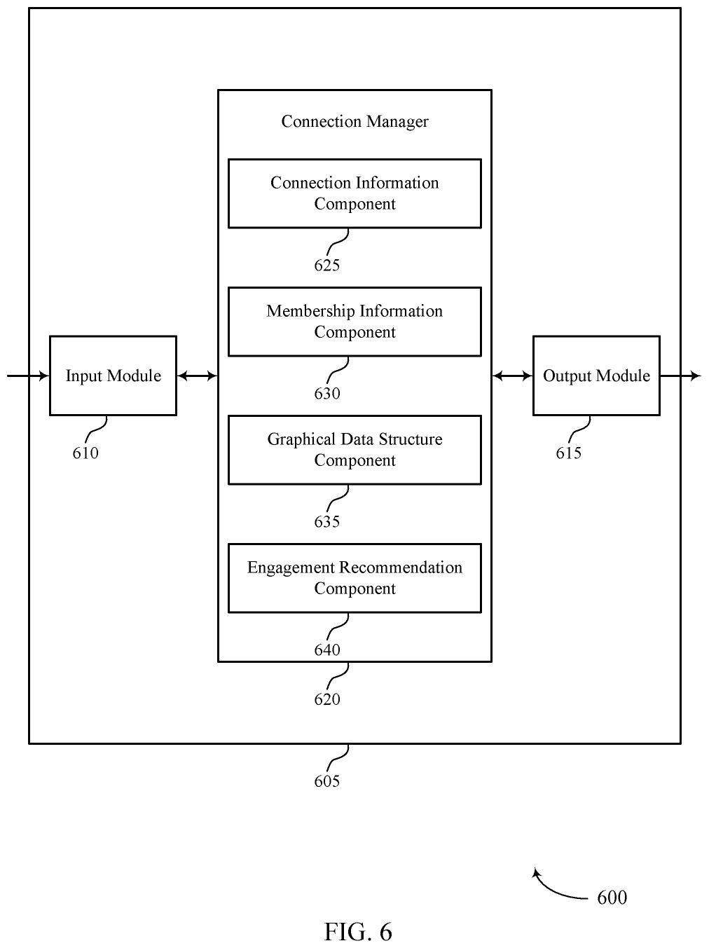

FIG. 6 illustrates a block diagram 600 of a device 605 that supports organizational collaboration connection recommendations in accordance with examples as disclosed herein. The device 605 may include an input module 610, an output module 615, and a connection manager 620. The device 605 may also include a processor. Each of these components may be in communication with one another (e.g., via one or more buses).

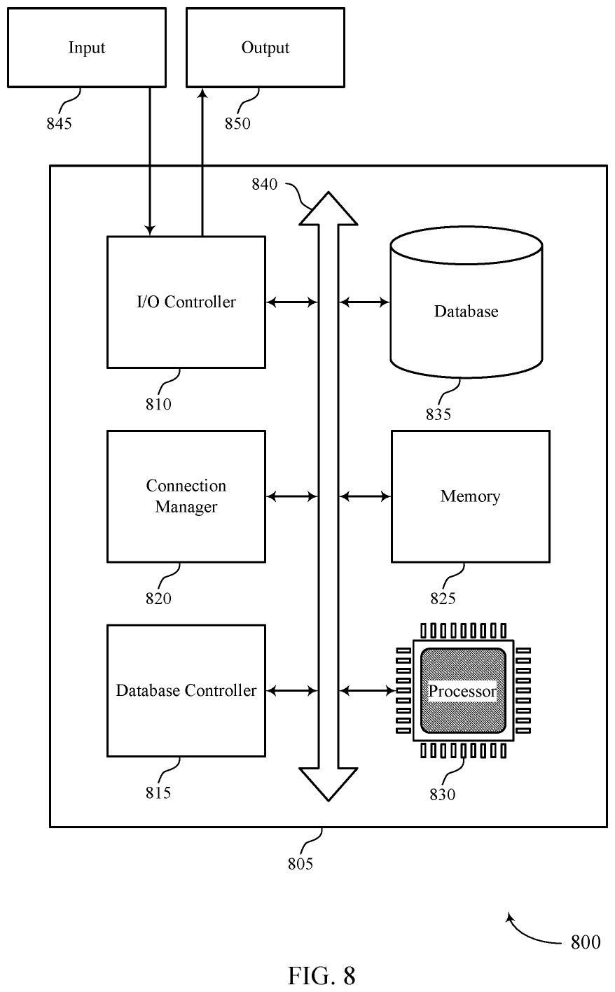

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the connection manager 620 to support organizational collaboration connection recommendations. In some cases, the input module 610 may be a component of an I/O controller 810 as described with reference to FIG. 8.

The output module 615 may manage output signals for the device 605. For example, the output module 615 may receive signals from other components of the device 605, such as the connection manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the connection manager 620 may include a connection information component 625, a membership information component 630, a graphical data structure component 635, an engagement recommendation component 640, or any combination thereof. In some examples, the connection manager 620, or various components thereof, may be configured to perform various operations (e.g., receiving, monitoring, transmitting) using or otherwise in cooperation with the input module 610, the output module 615, or both. For example, the connection manager 620 may receive information from the input module 610, send information to the output module 615, or be integrated in combination with the input module 610, the output module 615, or both to receive information, transmit information, or perform various other operations as described herein.

The connection manager 620 may support data processing in accordance with examples as disclosed herein. The connection information component 625 may be configured as or otherwise support a means for retrieving, from a first data source associated with a group-based communication platform associated with an entity, connection information of a set of multiple users of the group-based communication platform, the connection information corresponding to inclusion of individual users of the set of multiple users in one or more communication channels of the group-based communication platform. The membership information component 630 may be configured as or otherwise support a means for retrieving, from a second data source associated with the entity, membership information of the set of multiple users, the membership information corresponding to inclusion of the individual users of the set of multiple users in one or more groups of a set of multiple groups associated with the entity. The graphical data structure component 635 may be configured as or otherwise support a means for generating a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof. The engagement recommendation component 640 may be configured as or otherwise support a means for generating, based on the connection information, the membership information, and the graphical data structure, an engagement recommendation for users of the set of multiple users included in a first group of the one or more groups to engage with users of the set of multiple users included in a second group of the one or more groups.

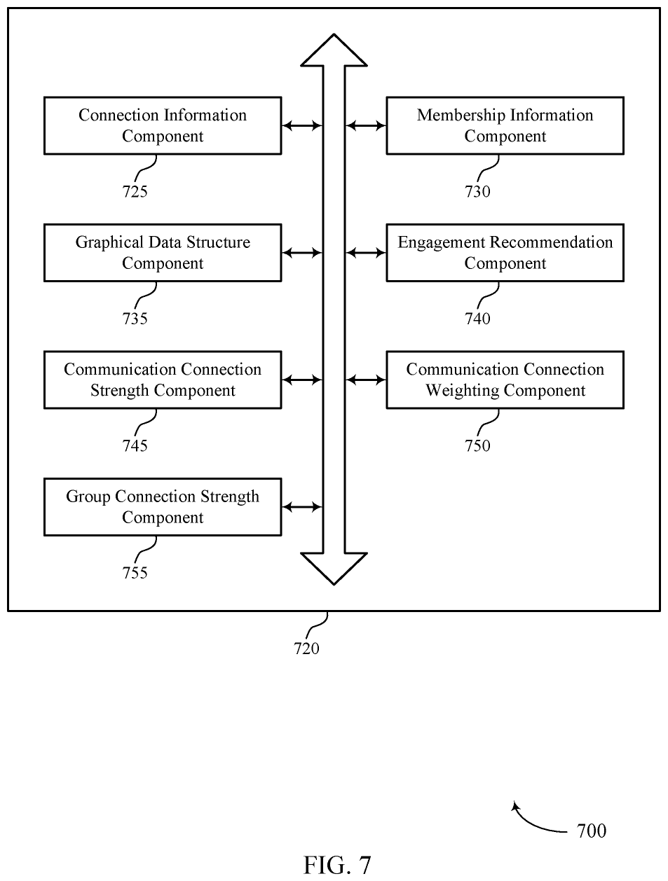

FIG. 7 illustrates a block diagram 700 of a connection manager 720 that supports organizational collaboration connection recommendations in accordance with examples as disclosed herein. The connection manager 720 may be an example of aspects of a connection manager or a connection manager 620, or both, as described herein. The connection manager 720, or various components thereof, may be an example of means for performing various aspects of organizational collaboration connection recommendations as described herein. For example, the connection manager 720 may include a connection information component 725, a membership information component 730, a graphical data structure component 735, an engagement recommendation component 740, a communication connection strength component 745, a communication connection weighting component 750, a group connection strength component 755, or any combination thereof. Each of these components may communicate, directly or indirectly, with one another (e.g., via one or more buses).

The connection manager 720 may support data processing in accordance with examples as disclosed herein. The connection information component 725 may be configured as or otherwise support a means for retrieving, from a first data source associated with a group-based communication platform associated with an entity, connection information of a set of multiple users of the group-based communication platform, the connection information corresponding to inclusion of individual users of the set of multiple users in one or more communication channels of the group-based communication platform. The membership information component 730 may be configured as or otherwise support a means for retrieving, from a second data source associated with the entity, membership information of the set of multiple users, the membership information corresponding to inclusion of the individual users of the set of multiple users in one or more groups of a set of multiple groups associated with the entity. The graphical data structure component 735 may be configured as or otherwise support a means for generating a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof. The engagement recommendation component 740 may be configured as or otherwise support a means for generating, based on the connection information, the membership information, and the graphical data structure, an engagement recommendation for users of the set of multiple users included in a first group of the one or more groups to engage with users of the set of multiple users included in a second group of the one or more groups.

In some examples, the communication connection strength component 745 may be configured as or otherwise support a means for generating communication connection strength values between the individual users indicated in the connection information based on one or more communication connections between the individual users, where the engagement recommendation is generated based on generating the communication connection strength values.

In some examples, the one or more communication connections between the individual users are weighted based on a quantity of interaction events performed by the individual users, a quantity of the individual users participating in the one or more communication channels, a period of time since a last interaction event occurred in the one or more communication channels, whether the individual users voluntarily joined the one or more communication channels, or any combination thereof.

In some examples, the group connection strength component 755 may be configured as or otherwise support a means for generating group connection strength values between individual groups of the set of multiple groups associated with the entity based on the membership information and the communication connection strength values between users of the individual groups. In some examples, the engagement recommendation component 740 may be configured as or otherwise support a means for where the engagement recommendation is generated based on a first group connection strength value of the group connection strength values that is associated with the first group and the second group.

In some examples, the one or more communication channels include one or more group communication channels, one or more one-on-one communication channels, or any combination thereof.

In some examples, the one or more groups associated with the entity correspond to one or more functional roles of the set of multiple users within the entity.

FIG. 8 illustrates a diagram of a system 800 including a device 805 that supports organizational collaboration connection recommendations in accordance with examples as disclosed herein. The device 805 may be an example of or include the components of a device 605 as described herein. The device 805 may include components for bi-directional data communications including components for transmitting and receiving communications, such as a connection manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor 830 to perform various functions described herein. In some cases, the memory 825 may contain, among other things, a BIOS which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting organizational collaboration connection recommendations).

The connection manager 820 may support data processing in accordance with examples as disclosed herein. For example, the connection manager 820 may be configured as or otherwise support a means for retrieving, from a first data source associated with a group-based communication platform associated with an entity, connection information of a set of multiple users of the group-based communication platform, the connection information corresponding to inclusion of individual users of the set of multiple users in one or more communication channels of the group-based communication platform. The connection manager 820 may be configured as or otherwise support a means for retrieving, from a second data source associated with the entity, membership information of the set of multiple users, the membership information corresponding to inclusion of the individual users of the set of multiple users in one or more groups of a set of multiple groups associated with the entity. The connection manager 820 may be configured as or otherwise support a means for generating a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof. The connection manager 820 may be configured as or otherwise support a means for generating, based on the connection information, the membership information, and the graphical data structure, an engagement recommendation for users of the set of multiple users included in a first group of the one or more groups to engage with users of the set of multiple users included in a second group of the one or more groups.

By including or configuring the connection manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

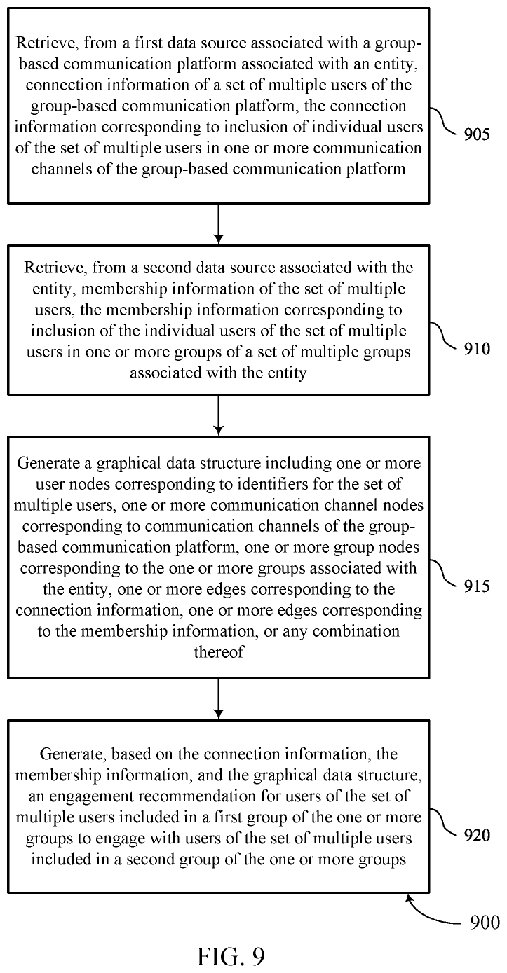

FIG. 9 illustrates a flowchart showing a method 900 that supports organizational collaboration connection recommendations in accordance with examples as disclosed herein. The operations of the method 900 may be implemented by an application server or its components as described herein. For example, the operations of the method 900 may be performed by an application server as described with reference to FIGS. 1 through 8. In some examples, an application server may execute a set of instructions to control the functional elements of the application server to perform the described functions. Additionally, or alternatively, the application server may perform aspects of the described functions using special-purpose hardware.

At 905, the method may include retrieving, from a first data source associated with a group-based communication platform associated with an entity, connection information of a set of multiple users of the group-based communication platform, the connection information corresponding to inclusion of individual users of the set of multiple users in one or more communication channels of the group-based communication platform. The operations of 905 may be performed in accordance with examples as disclosed herein. In some examples, aspects of the operations of 905 may be performed by a connection information component 725 as described with reference to FIG. 7.

At 910, the method may include retrieving, from a second data source associated with the entity, membership information of the set of multiple users, the membership information corresponding to inclusion of the individual users of the set of multiple users in one or more groups of a set of multiple groups associated with the entity. The operations of 910 may be performed in accordance with examples as disclosed herein. In some examples, aspects of the operations of 910 may be performed by a membership information component 730 as described with reference to FIG. 7.

At 915, the method may include generating a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof. The operations of 915 may be performed in accordance with examples as disclosed herein. In some examples, aspects of the operations of 915 may be performed by a graphical data structure component 735 as described with reference to FIG. 7.

At 920, the method may include generating, based on the connection information, the membership information, and the graphical data structure, an engagement recommendation for users of the set of multiple users included in a first group of the one or more groups to engage with users of the set of multiple users included in a second group of the one or more groups. The operations of 920 may be performed in accordance with examples as disclosed herein. In some examples, aspects of the operations of 920 may be performed by an engagement recommendation component 740 as described with reference to FIG. 7.

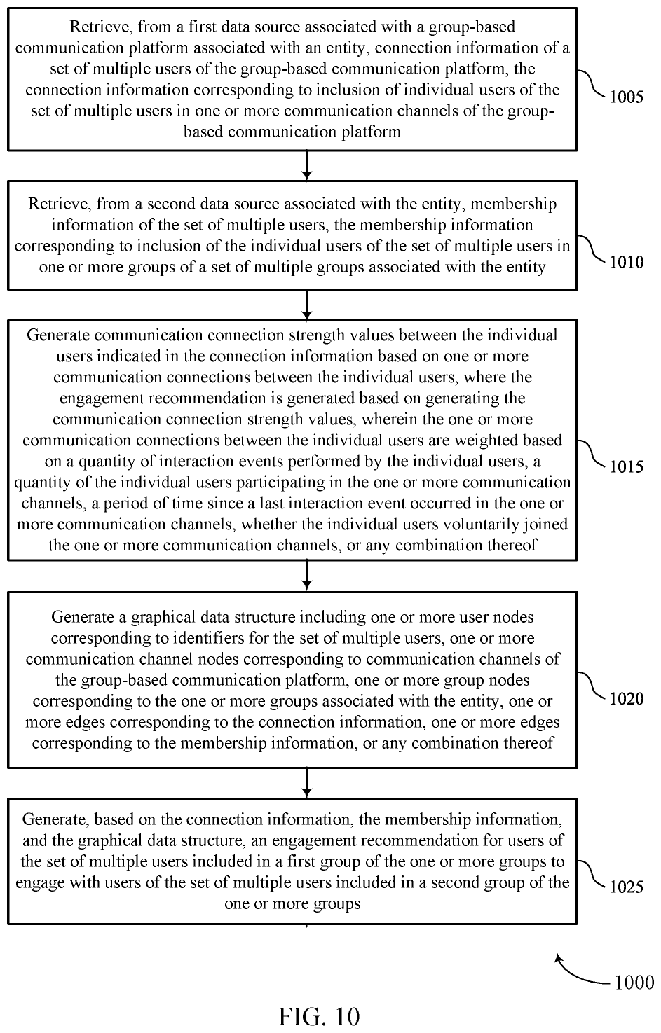

FIG. 10 illustrates a flowchart showing a method 1000 that supports organizational collaboration connection recommendations in accordance with examples as disclosed herein. The operations of the method 1000 may be implemented by an application server or its components as described herein. For example, the operations of the method 1000 may be performed by an application server as described with reference to FIGS. 1 through 8. In some examples, an application server may execute a set of instructions to control the functional elements of the application server to perform the described functions. Additionally, or alternatively, the application server may perform aspects of the described functions using special-purpose hardware.

At 1005, the method may include retrieving, from a first data source associated with a group-based communication platform associated with an entity, connection information of a set of multiple users of the group-based communication platform, the connection information corresponding to inclusion of individual users of the set of multiple users in one or more communication channels of the group-based communication platform. The operations of 1005 may be performed in accordance with examples as disclosed herein. In some examples, aspects of the operations of 1005 may be performed by a connection information component 725 as described with reference to FIG. 7.

At 1010, the method may include retrieving, from a second data source associated with the entity, membership information of the set of multiple users, the membership information corresponding to inclusion of the individual users of the set of multiple users in one or more groups of a set of multiple groups associated with the entity. The operations of 1010 may be performed in accordance with examples as disclosed herein. In some examples, aspects of the operations of 1010 may be performed by a membership information component 730 as described with reference to FIG. 7.

At 1015, the method may include generating communication connection strength values between the individual users indicated in the connection information based on one or more communication connections between the individual users, where the engagement recommendation is generated based on generating the communication connection strength values, wherein the one or more communication connections between the individual users being weighted based on a quantity of interaction events performed by the individual users, a quantity of the individual users participating in the one or more communication channels, a period of time since a last interaction event occurred in the one or more communication channels, whether the individual users voluntarily joined the one or more communication channels, or any combination thereof. The operations of 1015 may be performed in accordance with examples as disclosed herein. In some examples, aspects of the operations of 1015 may be performed by a communication connection strength component 745, a communication connection weighting component 750, or both, as described with reference to FIG. 7.

At 1020, the method may include generating a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof. The operations of 1020 may be performed in accordance with examples as disclosed herein. In some examples, aspects of the operations of 1020 may be performed by a graphical data structure component 735 as described with reference to FIG. 7.

At 1025, the method may include generating, based on the connection information, the membership information, and the graphical data structure, an engagement recommendation for users of the set of multiple users included in a first group of the one or more groups to engage with users of the set of multiple users included in a second group of the one or more groups. The operations of 1025 may be performed in accordance with examples as disclosed herein. In some examples, aspects of the operations of 1025 may be performed by an engagement recommendation component 740 as described with reference to FIG. 7.

A method for data processing is described. The method may include retrieving, from a first data source associated with a group-based communication platform associated with an entity, connection information of a set of multiple users of the group-based communication platform, the connection information corresponding to inclusion of individual users of the set of multiple users in one or more communication channels of the group-based communication platform, retrieving, from a second data source associated with the entity, membership information of the set of multiple users, the membership information corresponding to inclusion of the individual users of the set of multiple users in one or more groups of a set of multiple groups associated with the entity, generating a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof, and generating, based on the connection information, the membership information, and the graphical data structure, an engagement recommendation for users of the set of multiple users included in a first group of the one or more groups to engage with users of the set of multiple users included in a second group of the one or more groups.

An apparatus for data processing is described. The apparatus may include a processor, memory coupled with the processor, and instructions stored in the memory. The instructions may be executable by the processor to cause the apparatus to retrieve, from a first data source associated with a group-based communication platform associated with an entity, connection information of a set of multiple users of the group-based communication platform, the connection information corresponding to inclusion of individual users of the set of multiple users in one or more communication channels of the group-based communication platform, retrieve, from a second data source associated with the entity, membership information of the set of multiple users, the membership information corresponding to inclusion of the individual users of the set of multiple users in one or more groups of a set of multiple groups associated with the entity, generate a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof, and generate, based on the connection information, the membership information, and the graphical data structure, an engagement recommendation for users of the set of multiple users included in a first group of the one or more groups to engage with users of the set of multiple users included in a second group of the one or more groups.

Another apparatus for data processing is described. The apparatus may include means for retrieving, from a first data source associated with a group-based communication platform associated with an entity, connection information of a set of multiple users of the group-based communication platform, the connection information corresponding to inclusion of individual users of the set of multiple users in one or more communication channels of the group-based communication platform, means for retrieving, from a second data source associated with the entity, membership information of the set of multiple users, the membership information corresponding to inclusion of the individual users of the set of multiple users in one or more groups of a set of multiple groups associated with the entity, means for generating a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof, and means for generating, based on the connection information, the membership information, and the graphical data structure, an engagement recommendation for users of the set of multiple users included in a first group of the one or more groups to engage with users of the set of multiple users included in a second group of the one or more groups.

A non-transitory computer-readable medium storing code for data processing is described. The code may include instructions executable by a processor to retrieve, from a first data source associated with a group-based communication platform associated with an entity, connection information of a set of multiple users of the group-based communication platform, the connection information corresponding to inclusion of individual users of the set of multiple users in one or more communication channels of the group-based communication platform, retrieve, from a second data source associated with the entity, membership information of the set of multiple users, the membership information corresponding to inclusion of the individual users of the set of multiple users in one or more groups of a set of multiple groups associated with the entity, generate a graphical data structure including one or more user nodes corresponding to identifiers for the set of multiple users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof, and generate, based on the connection information, the membership information, and the graphical data structure, an engagement recommendation for users of the set of multiple users included in a first group of the one or more groups to engage with users of the set of multiple users included in a second group of the one or more groups.

Some examples of the method, apparatuses, and non-transitory computer-readable medium described herein may further include operations, features, means, or instructions for generating communication connection strength values between the individual users indicated in the connection information based on one or more communication connections between the individual users, where the engagement recommendation may be generated based on generating the communication connection strength values.

In some examples of the method, apparatuses, and non-transitory computer-readable medium described herein, the one or more communication connections between the individual users may be weighted based on a quantity of interaction events performed by the individual users, a quantity of the individual users participating in the one or more communication channels, a period of time since a last interaction event occurred in the one or more communication channels, whether the individual users voluntarily joined the one or more communication channels, or any combination thereof.

Some examples of the method, apparatuses, and non-transitory computer-readable medium described herein may further include operations, features, means, or instructions for generating group connection strength values between individual groups of the set of multiple groups associated with the entity based on the membership information and the communication connection strength values between users of the individual groups and where the engagement recommendation may be generated based on a first group connection strength value of the group connection strength values that may be associated with the first group and the second group.

In some examples of the method, apparatuses, and non-transitory computer-readable medium described herein, the one or more communication channels include one or more group communication channels, one or more one-on-one communication channels, or any combination thereof.

In some examples of the method, apparatuses, and non-transitory computer-readable medium described herein, the one or more groups associated with the entity correspond to one or more functional roles of the set of multiple users within the entity.

The following provides an overview of aspects of the present disclosure:

Aspect 1: A method for data processing, comprising: retrieving, from a first data source associated with a group-based communication platform associated with an entity, connection information of a plurality of users of the group-based communication platform, the connection information corresponding to inclusion of individual users of the plurality of users in one or more communication channels of the group-based communication platform; retrieving, from a second data source associated with the entity, membership information of the plurality of users, the membership information corresponding to inclusion of the individual users of the plurality of users in one or more groups of a plurality of groups associated with the entity: generating a graphical data structure comprising one or more user nodes corresponding to identifiers for the plurality of users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof: and generating, based at least in part on the connection information, the membership information, and the graphical data structure, an engagement recommendation for users of the plurality of users included in a first group of the one or more groups to engage with users of the plurality of users included in a second group of the one or more groups.

Aspect 2: The method of aspect 1, further comprising: generating communication connection strength values between the individual users indicated in the connection information based at least in part on one or more communication connections between the individual users, wherein the engagement recommendation is generated based at least in part on generating the communication connection strength values.

Aspect 3: The method of aspect 2, wherein the one or more communication connections between the individual users are weighted based at least in part on a quantity of interaction events performed by the individual users, a quantity of the individual users participating in the one or more communication channels, a period of time since a last interaction event occurred in the one or more communication channels, whether the individual users voluntarily joined the one or more communication channels, or any combination thereof.

Aspect 4: The method of any of aspects 2 through 3, further comprising: generating group connection strength values between individual groups of the plurality of groups associated with the entity based at least in part on the membership information and the communication connection strength values between users of the individual groups: wherein the engagement recommendation is generated based at least in part on a first group connection strength value of the group connection strength values that is associated with the first group and the second group.

Aspect 5: The method of any of aspects 1 through 4, wherein the one or more communication channels comprise one or more group communication channels, one or more one-on-one communication channels, or any combination thereof.

Aspect 6: The method of any of aspects 1 through 5, wherein the one or more groups associated with the entity correspond to one or more functional roles of the plurality of users within the entity.

Aspect 7: An apparatus for data processing, comprising a processor: memory coupled with the processor: and instructions stored in the memory and executable by the processor to cause the apparatus to perform a method of any of aspects 1 through 6.

Aspect 8: An apparatus for data processing, comprising at least one means for performing a method of any of aspects 1 through 6.

Aspect 9: A non-transitory computer-readable medium storing code for data processing, the code comprising instructions executable by a processor to perform a method of any of aspects 1 through 6.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary.” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
retrieving, from a first data source associated with a group-based communication platform associated with an entity, connection information of a plurality of users of the group-based communication platform, the connection information corresponding to inclusion of individual users of the plurality of users in one or more communication channels of the group-based communication platform;
retrieving, from a second data source associated with the entity, membership information of the plurality of users, the membership information corresponding to inclusion of the individual users of the plurality of users in one or more groups of a plurality of groups associated with the entity;
generating a graphical data structure comprising one or more user nodes corresponding to identifiers for the plurality of users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof; and
generating, based at least in part on the connection information, the membership information, and the graphical data structure, an engagement recommendation for users of the plurality of users included in a first group of the one or more groups to engage with users of the plurality of users included in a second group of the one or more groups.

2. The method of claim 1, further comprising:
generating communication connection strength values between the individual users indicated in the connection information based at least in part on one or more communication connections between the individual users, wherein the engagement recommendation is generated based at least in part on generating the communication connection strength values.

3. The method of claim 2, wherein the one or more communication connections between the individual users are weighted based at least in part on a quantity of interaction events performed by the individual users, a quantity of the individual users participating in the one or more communication channels, a period of time since a last interaction event occurred in the one or more communication channels, whether the individual users voluntarily joined the one or more communication channels, or any combination thereof.

4. The method of claim 2, further comprising:
generating group connection strength values between individual groups of the plurality of groups associated with the entity based at least in part on the membership information and the communication connection strength values between users of the individual groups;
wherein the engagement recommendation is generated based at least in part on a first group connection strength value of the group connection strength values that is associated with the first group and the second group.

5. The method of claim 1, wherein the one or more communication channels comprise one or more group communication channels, one or more one-on-one communication channels, or any combination thereof.

6. The method of claim 1, wherein the one or more groups associated with the entity correspond to one or more functional roles of the plurality of users within the entity.

7. An apparatus for data processing, comprising:
a processor;
memory coupled with the processor; and
instructions stored in the memory and executable by the processor to cause the apparatus to:
retrieve, from a first data source associated with a group-based communication platform associated with an entity, connection information of a plurality of users of the group-based communication platform, the connection information corresponding to inclusion of individual users of the plurality of users in one or more communication channels of the group-based communication platform;
retrieve, from a second data source associated with the entity, membership information of the plurality of users, the membership information corresponding to inclusion of the individual users of the plurality of users in one or more groups of a plurality of groups associated with the entity;
generate a graphical data structure comprising one or more user nodes corresponding to identifiers for the plurality of users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof; and
generate, based at least in part on the connection information, the membership information, and the graphical data structure, an engagement recommendation for users of the plurality of users included in a first group of the one or more groups to engage with users of the plurality of users included in a second group of the one or more groups.

8. The apparatus of claim 7, wherein the instructions are further executable by the processor to cause the apparatus to:
generate communication connection strength values between the individual users indicated in the connection information based at least in part on one or more communication connections between the individual users, wherein the engagement recommendation is generated based at least in part on generating the communication connection strength values.

9. The apparatus of claim 8, wherein the one or more communication connections between the individual users are weighted based at least in part on a quantity of interaction events performed by the individual users, a quantity of the individual users participating in the one or more communication channels, a period of time since a last interaction event occurred in the one or more communication channels, whether the individual users voluntarily joined the one or more communication channels, or any combination thereof.

10. The apparatus of claim 8, wherein the instructions are further executable by the processor to cause the apparatus to:
generate group connection strength values between individual groups of the plurality of groups associated with the entity based at least in part on the membership information and the communication connection strength values between users of the individual groups;
wherein the engagement recommendation is generated based at least in part on a first group connection strength value of the group connection strength values that is associated with the first group and the second group.

11. The apparatus of claim 7, wherein the one or more communication channels comprise one or more group communication channels, one or more one-on-one communication channels, or any combination thereof.

12. The apparatus of claim 7, wherein the one or more groups associated with the entity correspond to one or more functional roles of the plurality of users within the entity.

13. A non-transitory computer-readable medium storing code for data processing, the code comprising instructions executable by a processor to:
retrieve, from a first data source associated with a group-based communication platform associated with an entity, connection information of a plurality of users of the group-based communication platform, the connection information corresponding to inclusion of individual users of the plurality of users in one or more communication channels of the group-based communication platform;
retrieve, from a second data source associated with the entity, membership information of the plurality of users, the membership information corresponding to inclusion of the individual users of the plurality of users in one or more groups of a plurality of groups associated with the entity;
generate a graphical data structure comprising one or more user nodes corresponding to identifiers for the plurality of users, one or more communication channel nodes corresponding to communication channels of the group-based communication platform, one or more group nodes corresponding to the one or more groups associated with the entity, one or more edges corresponding to the connection information, one or more edges corresponding to the membership information, or any combination thereof; and
generate, based at least in part on the connection information, the membership information, and the graphical data structure, an engagement recommendation for users of the plurality of users included in a first group of the one or more groups to engage with users of the plurality of users included in a second group of the one or more groups.

14. The non-transitory computer-readable medium of claim 13, wherein the instructions are further executable by the processor to:
generate communication connection strength values between the individual users indicated in the connection information based at least in part on one or more communication connections between the individual users, wherein the engagement recommendation is generated based at least in part on generating the communication connection strength values.

15. The non-transitory computer-readable medium of claim 14, wherein the one or more communication connections between the individual users are weighted based at least in part on a quantity of interaction events performed by the individual users, a quantity of the individual users participating in the one or more communication channels, a period of time since a last interaction event occurred in the one or more communication channels, whether the individual users voluntarily joined the one or more communication channels, or any combination thereof.

16. The non-transitory computer-readable medium of claim 14, wherein the instructions are further executable by the processor to:
generate group connection strength values between individual groups of the plurality of groups associated with the entity based at least in part on the membership information and the communication connection strength values between users of the individual groups;
wherein the engagement recommendation is generated based at least in part on a first group connection strength value of the group connection strength values that is associated with the first group and the second group.

17. The non-transitory computer-readable medium of claim 13, wherein the one or more communication channels comprise one or more group communication channels, one or more one-on-one communication channels, or any combination thereof.

18. The non-transitory computer-readable medium of claim 13, wherein the one or more groups associated with the entity correspond to one or more functional roles of the plurality of users within the entity.
